(19) United States
(12) Patent Application Publication
(10) Pub. No.: US 2006/0246412 A1
(43) Pub. Date: Nov. 2, 2006

(54) Professor Pieczenik's instruction method and system

(76) Inventor: George Pieczenik, New York, NY (US)

Correspondence Address: DR. GEORGE PIECZENIK, APT. 1F, 412 EAST 55TH STREET, NEW YORK, NY, 10022, US

(21) Appl. No.: 11/120,745

(22) Filed: May 1, 2005

(51) Int. Cl. G09B 3/00

(52) U.S. Cl. 434/350

(57) ABSTRACT

The Professor Pieczenik Instruction Method and System (PPIMS) allows students to learn contemporary scientific material economically and easily. It comprises hardware and software to record and make live lectures available to students and an internet contact point comprising information and communication with the lecturer. Data showing two grade point improvement for the majority of the class with the PPIMS in conceptually difficult molecular biology and biochemistry course instruction is presented.

The following invention relates to a method and system, named the Professor Pieczenik's Instructional Method and System (PPIMS), to improve student performance in college level lecture courses with large number of students. It is a method and system comprising an internet and CD video copy as back up for these live lectures combined with an internet based contact point, such as Yahoo Groups. This allows for student access to the lecture, to subject matter and technical information assigned (through links, files, documents, photos) and twenty-four hour access to the lecturer, fellow student colleagues and remote invited lecturers as a supplement to the lecture. Experimental data employing PPIMS shows the student's ability to access the video recorded live lectures as digitial files on an internet accessible server, or through file sharing systems, or through CDs and through transcripts of these lectures. This additional access to the infromation allows the student to understand and absorb the material better than just having access to the live lecture and notes taken thereof.

The utility and effectiveness of PPIMS can be demonstrated with data collected during the Spring Semester of Biochemistry 301 at Rutgers University from, the inventor, Professor Pieczenik's teaching over 145 students in his Introduction to Biochemistry Course. This data shows objective evidence of grade improvement of, at least, one but more often, two grade levels (C to A) for those students preferentially employing both live lecture and video repetition versus students just employing preferentially live lecture or preferentially videos of the lectures. This novel PPIMS allows access to information that is current, in flux and conceptually difficult. This requires continuous personal 24 hour interaction with the professor which PPIMS supplies. PPIMS demonstrates its uniqueness and effectiveness in such areas as in informational molecular biology, combinatorial chemistry, biochemistry, microbiology, bio-informatics, genomics, proteomics, embryology, stem cell methodology, cloning, biotech patenting, biotech business, inter alia. Scientific publications are usually 1-2 years behind the discovery of information in these areas. Textbooks are 3-5 years behind these publications. Therefore, the textbooks available to college level science students are obsolete in rapidly changing areas such as genomics, proteomics, molecular biology, molecular embryology, biochemistry, microbiology, inter alia. The PPIMS allows students access to this newer information in a timely and immediate manner with the repetition and re-enforcement historically available through textbooks. Students trained with PPIMS are cutting edge pre-medical students and pre-graduate students and are accepted wherever they apply.

The PPIMS addresses the technical difficulties in supplying at least twenty 80 minute videos of live lectures on-line and accessible to at lest one hundred students at any given time. Each lecture has a minimum of 400 million Memory Element Groups (Meg). Therefore, a whole course contains at least 26 lectures and 2-3 exams. This means a minimum of over 10 Gig of memory. Issues such as upload and download times, speed of transfer, limits on information transfer of bits per unit time, file transfer between computers and hubs, have been addressed by the inventor and his support staff to make PPMIS effective and financially modest per course i.e. under one thousand dollars in a private server environment or at a University server and memory to have been addressed by creating adaptors and memory disks on-line at the Professor's home. PPMIS allows teaching an advance course with the need for textbooks. Textbook cost to the students for a course with at least 100 students in the biochemical sciences range in price is around 150/book or one thousand five hundred dollars per course. Students are now actively campaigning against the excessively high cost of textbooks. However, textbooks in course where the material is static can be re-purchased on-line at discount re-sellers. This is not available to students in non-static courses.

Universities usually supply only 1-2 Gig of memory to each faculty member for their use and their instructional course use. This is the standard practice at Rutger's University, which is the State University of New Jersey, with over 5,000 senior faculty and 50,000 students. This amount of memory is not sufficient to use PPMIS. The inventor created several novel solutions to this problem.

In one embodiment, PPIMS uses a D-Link DNS 120 USB—attachable—Network Storage Adaptor to which one attaches a 250 Gig of Western Digital-USB attachable external hard drive. The Network Storage Adaptor has an FTP server function so that files can be transferred to any student computer accessing this adaptor with File Transfer Protocols or FTP i.e. ftp://68.1 74.133.234. These two units working in combination effectively acts as a private home server for any course using PPIMS and is called the PPIMS server. It is a virtual course. The lectures are accessible 24 hours a day, 7 days a week from the internet by anyone allowed. The IP address of this PPIMS server is IP 68.174.133.234 and it can be accessed by the following on any web browser using the following FTP address—ftp://68.174.133.234. The total cost to the Professor for the adaptor and the memory was approximately under 500 hundred dollars. The PPIMS server holds all the videos of all the lectures in uncompressed format, MPEG, at over 400 Meg/lecture, duplicates of all the videos of all the lectures in Quick Time accessible compressed format (at lower resolution), over the articles assigned, past examinations and answers, the movies that are supplemental to the course, such as Photo 51, Life Story, the Nazi Doctors, The Man Who Never Was, and Something the Lord Made, etc. The PPIMS server is independent of the University computer system and can be maintained and controlled relatively easily and cheaply by a Professor with cable or DSL internet access. The cost of the PPIMS server in 2005 is $229 for Western Digital External Memory

http://store.westerndigital.com/product.asp?sku=2595168 and $89 for the D-Link Adaptor or $318.00 http://www.dlink.com/products/?pid=352. This PPIMS server can handle 25 such courses at a time. This would be in excess of a students four year course requirement for graduation in a major such as biochemistry, excluding laboratory courses.

The information on a PPIMS server can be replicated from the home environment of the Professor into the University by such commercially at Neo-Modus http://www.neo-modus.com/ which offers file sharing programs such as Direct-Connect. Direct Connect was used in the Biochemistry 301 PPIMS to replicate the information on the PPMIS server and to create a “hub” so that Rutger's students in the course could access the information at ten fold higher transfer rates with ten fold higher load volume.

College level science courses, such as molecular biology, biochemistry and microbiology are evolving very rapidly. The completion of the human genome recently has made many textbooks and courses in these areas relatively obsolete. Methods of instructions that are rapid and re-enforcing and accessible 24/7 at the college level as well as the high school level are needed.

The emergence of the Internet has given rise to a growing number of online educational institutions including eCollege, (http://www.ecollege.com/) and Virtual Online University, (http://www.vousi.com/), and on-line law schools such as Concord Law

(http://www.concordlawschool.com/info/custom/concord/index.asp?source=600019)

The problem with online educational institutions is that typically students fall behind in the course work as they can access the material at any time and, therefore, they procrastinate to the last moment. This does not allow for any repetition of the material and denies the student the direct access to the lecturer or Professor in any timely fashion. This can be seen with data presented that shows that students given the choice of watching a lecture on video or accessible through the internet usually do not do so, if there will be a live lecture by the Professor on the same material in which direct interaction of question and answers can occur. However, historically, students who come to lecture and take notes have only one chance to capture the Professors words. This is also under the time pressure of the lecture which is usually 80 minutes. This is a long period of time to focus concentration and usually the mind wonders on an important or interesting point of lecture only to find a specific piece of information was missed. This historically was addressed by questions to the Professor or during office hours. However, with class sizes now doubling every two years, which for example the inventor's biochemistry course doubled in size from about 75 students two years ago to over 150 students presently. Office hours where one meets with each student only once for 2 hour would generate office hour times of 75 hours, which would be one full day every week of the whole course. This is difficult to do and not sufficient time to re-explain difficult lectures. To meet for 1 hour with each student to explain 23-26 lectures would not be possible. Therefore, the video record of the live lecture allows the Professor to amplify his time and teaching. This amplification is then reamplified through file sharing and discussions on the Group web site which can meet online also at designated time.

The PPIMS allows the Professor to have extensive Chat hours with the students who are interested the evening of any examination. Two such Chat of over 3 hours each with over 30 students at a time occurred on line before the 2^{nd} and 3^{rd} hourly of a Biochemistry Course and allowed the Professor to answer questions about these examination and relieve fears of ignorance and anxiety in the students The students were also able to access each other for questions and answers. It effectively created a large study group for students without the classical problems of social interaction and prejudices. PPIMS allows gender-free, minority-free, sexuality-free interaction among students and allows the evolution of diversity of intellectual interaction. In addition, because many Universities have to address the religious beliefs of students and their inability to attend classes on their respective religious holidays, PPIMS allows these students access to the lectures without having to explain or even address these issues. This makes for a more secular based educational system which is more consistent the separation of church and state functions in University State institutions which must address the religious sensitivities and, yet, not subordinate their secular functions to religious constraints. This is also evident in issues involving subject matter where evolution and stem cell embryology is taught. PPIMS allows students their own decisions about accessing this information or not and not being held accountable for differing views.

PPIMS addresses another instructional demographic. In the United States, there is now an over 50 percent divorce rate. This usually means that women are left to their own resources and needing to raise children with an education that had previously been terminated to the demands of marriage and child-bearing and rearing. The demographic of older women coming back to complete their degrees is very effectively addressed by PPIMS. Professor Pieczenik has trained many divorced single mothers using PPIMS and given them the foundation to enter medical school, nursing school, law school, nutrition, pharmacy, graduate school, pharmaceutical sales and research, inter/alia. The advantage of PPIMS is that the mother has a chance to get away from her family obligations for a little while for the live lecture and then has a chance to view and share the lectures at her leisure at home with her family. In addition, should a family crisis occur then PPIMS allows her to view the lecture directly at home without having to leave the house or fall behind.

PPIMS places the live lecture on the PPIMS server within 3 hours of the live lecture being given. Compressed versions of the lectures are placed on the PPIMS and University server within 4 hours of the live lecture. This is doable because the lectures, video and audio, were recorded by a DCR-TRV Sony digital video camcorder which has a SanDisk memory adaptor with a SanDisk 512 MB Memory Stick Pro Duo Gig which is immediately transferable to the Sony Vaio computer and notebook and then to the PPIMS server. The camcorder now sells for about $299.00. The Sony Vaio computer and notebooks can also burn CD's of these lectures which are available to the students. The lectures can also be transcribed manually and also by transcription programs to make a “hard copy” of the spoken lecture. The 400 MEG lecture without compression allows sufficient resolution to read the Professors writings on the blackboard. The compressed lectures show lower resolution and make the black board writing only decipherable with the spoken lecture or class notes previously taken. Higher resolution Camcorder using tape was use in one lecture and then fire wire transferred through soft ware programs to digital format at higher resolution. This may be adapted as a method in the future for PPIMS lectures. The advantage is that there is higher resolution in the initial recording but the time taken to convert the analogue picture to digital makes the ability to post the lecture on the same day more problematic. However, the best enablement of video where the Professor's writing on the blackboard is clearly visible in a 400 MEG MPEG file and placing this lecture on-line within the same day is using the Digital Memory Stick to preserve the lecture. However, other enablements would include recording on video tape and then transferring this to digital format. Compression programs used where the Clie Image Convertor by Sony Corp which converts video programs in MPEG format into MQV format which can by used by Clie Hand Held PDAs, and which can be changed to MOV which can be viewed by the free software for Quick Time available at www.apple.com. This allows a compression of a PPIMS lecture of 400 MEG in MPEG format into a PPIMS lecture of less than 100 MEG in MQV or MOV format. Once again, the compressed format is useful for rapid download and for checking notes already taken in the live class context as the written board resolution is ambiguous for small details. Enablements using supplemental Microsoft Office Power Point slides to the lecture where the black board material is duplicated in a slide fashion format are also to be included as an alternate enablement.

PPIMS also takes uses and advantage of the Yahoo Group methodology available on-line free at at reasonable cost to anyone with internet and browser capabilities. For example, a course Group is set up as a Yahoo Group. Alternate, internet groups are PalTalk, Microsoft Groups, Netscape Groups, and Google groups. The example below gives the general structure available in a Yahoo Group for a Biochemistryh Course. It has LINKS to the PPIMS server, to the University Server, to the Nobel Prize sites, to Genomic sequence sites, to Proteomic sequence sites, to political relevant sites to stem cell research. It has FILES to articles and publications. It has photos of chemical structures, x-ray diffraction photographs of DNA, foldable models of polio virus structure, alpha helix etc. It has MESSAGES to inform and discuss with the students administrative and scientific issues. It has CHAT which allows the class to interact in real time with the Professor and each other. It has POLLS which allow the Professor to evaluate the teaching methods in this course and identify the areas of strengths and weaknesses, of understanding and lack of comprehension.

Example 1 is a summary of a POLL taken on the Yahoo Group board of students taking Professor Pieczenik's Instructional Method and System as applied to Biochemistry 301 at Cook College, Rutgers University in Spring of 2005. It asks several questions: The first question interrogated the students to find out if this method of instruction was novel at Rutger's University over the 4 years the students took courses at Rutgers. Out of 17 students who answered the POLL all of them said that this was the first course they had taken which had on-line video back-up for all the lectures. Considering that these are 17 senior students having taken about 16-20 courses/a year for 4-5 years a piece, and considering duplication of courses as required by the major, some 400 to 1,300 course, this means that all 100 percent of those responding to the poll did not have back-up videos for their lectures at Rutgers University, in their 4-5 years. PPIMS is different than taking on-line courses or a correspondence courses with CDs mailed, as described in U.S. Pat. No. 6,869,287 by Tadlock, et. al. issued on Mar. 22, 2005 in a “method of teaching reading” and in U.S. Pat. No. 6,679,703 by Ailing issued on Jan. 20, 2004 describing a method of “virtual training”. PPIMS is meant as a back up for live lecturing which then becomes more effective. Live lectures backing up the video lecture was tried once, students did not watch the video in time for the supplemental live lecture and that video information had to be presented live. Therefore, videos alone have a problem with compliance, much like medication compliance; it is available but no everyone takes it. Only when the doctor or Professor in this case is watching does the pill get taken or the lecture attended and get noted.

PPIMS is a live “brick and mortar” lecture with on-line virtual back-up in support allowing for repetition and instruction.

The second question asked relates to the effectiveness of presenting material one time versus three times in terms of understanding and comprehension that can be tested on an exam. It shows that presenting material 3 times repeatedly has a comprehension ratio of 9 to 1, while teaching the material one time has a comprehension ration of 2/1. Therefore, the repetition factor increases comprehension by 4.5 fold. This experimental observation is statistically significant with a Chi-square of 4.9 with one degree of freedom. The p is less than or equal to 0.05 and therefore, significant versus the null hypothesis that repetition does not change or increase the comprehension.

This inventor believes he has demonstrated that this repetition factor is what makes PPIMS so effective. Having the video lectures on access the day of the lecture allows for an immediate repetition of material. That is once, at the lecture, and the second time repeating with the video at home. The third time is when notes are taken from the video to update the class notes. Therefore, one can readily see that the area of biochemistry of involving base pairing rules and interaction in the DNA duplex is called GonnoCNaToo. This was taught three separate times, the last time in French, to the same class in different lectures. The second area, the Sanger method of dideoxy DNA sequencing, which was taught one time was not learned as well.

### EXAMPLE 1

Objective Evidence of the Utility of PPIMS in Understanding Informational Molecular Biology and Biochemistry

Objective evidence of the Utility of Video Lectures
and Internet Group As Back Up for Live Lectures

| | Yes | Yes % | No | No % |
|---|---|---|---|---|
| Was this the first course you | 17 | 100 | 0 | 0 |
| took at Rutgers which had on- | | | | |
| line video back up of all the | | | | |
| lectures? | | | | |
| Did you get most of the base- | 38 | 91 | 4 | 9 |
| pairing GonnCnAToo questions | | | | |
| correctly? These I went over 3 | | | | |
| times in class. | | | | |
| Did you get the Sanger | 27 | 69 | 11 | 28 |
| sequencing questions right? | | | | |
| These I went over only once in | | | | |
| class. | | | | |

### EXAMPLE 2

Effectiveness of Video and Lecture Combination, the PPIMS, in Improving Greade Performance.

| | 90-100 | 90-100% | 80-89 | 80-89% | 70-79 | 70-79% | 60-69 | 60-69% | Below 60 | Below 60% |
|---|---|---|---|---|---|---|---|---|---|---|
| Grade attending | 15 | 53 | 6 | 21 | 5 | 17 | 2 | 7 | 0 | 0 |
| Lecture and Video | | | | | | | | | | |
| Grade attending | 12 | 36 | 9 | 27 | 6 | 18 | 0 | 0 | 6 | 19 |
| Lecture | | | | | | | | | | |
| Grade using Video | 3 | 13 | 7 | 31 | 6 | 27 | 3 | 13 | 3 | 13 |

Table 1 shows that 53 percent of the students who attended the live lectures and watched the videos and used the internet Group for assimilating the material in Biochemistry 301 at Rutgers University in the Spring of 2005, and responded to the poll, had a non-curved grade of an “A” on the first hourly. Only 13 percent of the students who predominantly used the back-up videos and the internet Goup programs received a non-curved grade of “A” on the first hourly. There were no students getting below a 60 percentile in the group using both lecture and video. Thirteen percent of students using just video received grades below 60 percentile. The grades differences received for the various group combinations and comparisons are statistically significant with a p that is less than or equal to 0.05. It has a Chi-square of 1 4.5 with 8 degrees of freedom.

In just comparing, students attending live lectures and repeating with back-up Videos to students just using back-up Videos and not attending lectures the Chi-Square was 1 0.8 with 4 degrees of freedom and statistically significant with a p that is less than or equal to 0.05.

Interestingly, while there is no statistical difference at the 0.05 percent level between attending Lecture and Video versus just Lecture alone, or Lecture alone vs Video alone, there is a statistical difference between Lecture and Video versus Video alone. This suggests that on-line virtual education is not effective as a primary method of instruction in comparison to it being used as a supplemental method of education and instruction. However, it also suggests that it is somewhat comparable to just live lectures alone if the repetition factor is eliminated.

What is clear, however, is that the PPIMS, using both live lectures and videos of those lectures with internet Group contact points, can deliver a superior contemporary educational product to the student, that is economic, easy to assimilate, contemporary and can rapidly evolve to incorporate new information as it is discovered. It can also improve student performance and Professor satisfaction by at least one to two grades for the majority of students.

What is claimed is:

1. A Professor Pieczenik Instructional Method and Sytem (PPIMS) server comprising a computer hardware combination comprising a network adaptor, said network adaptor having ftp server function and a 250 Gig memory hard disk attached to said network adaptor through a USB connection for storing and accessing digital videos of live lectures.

2. A Professor Pieczenik Instructional Method and System (PPIMS) comprising the steps of:
a) recording a live lecture with a camcorder; and
b) storing said live lecture recording in a digital format; and
c) transferring said live lecture digitally formatted recording to the PPIMS server of claim 1 or to a University server; and
d) making said live lecture digitally formatted recordings accessible to the internet for use and replication by file sharing; and
e) creating a Internet Group contact point such as Yahoo Groups for the course in which said lecture is given; and
f) placing web links, files, photos, articles on said internet group contact point; and
g) making said Internet Group available to students in said course through the internet;
h) allowing said students to access both the lecture videos on the PPIMS server and the internet Group so that the Professor Pieczenik Instructional Method and System is available to students for their better instruction.
